(19) United States
(12) Patent Application Publication
(10) Pub. No.: US 2017/0193361 A1
(43) Pub. Date: Jul. 6, 2017

(54) NEURAL NETWORK TRAINING PERFORMANCE OPTIMIZATION FRAMEWORK

(71) Applicant: Microsoft Technology Licensing, LLC, Redmond, WA (US)

(72) Inventors: Trishul A. Chilimbi, Seattle, WA (US); Olatunji Ruwase, Bothell, WA (US); Samyam Rajbhandari, Columbus, OH (US); Michael Carbin, Cambridge, MA (US); Yuxiong He, Seattle, WA (US)

(21) Appl. No.: 14/986,186

(22) Filed: Dec. 31, 2015

(51) Int. Cl. G06N 3/08

(52) U.S. Cl. CPC G06N 3/08

(57) ABSTRACT

A neural network training tool selects from a plurality of parallelizing techniques and selects from a plurality of forward-propagation computation techniques. The neural network training tool performs a forward-propagation phase to train a neural network using the selected parallelizing technique and the selected forward-propagation computation technique based on one or more inputs. Additionally, the neural network training tool selects from a plurality computation techniques and from a plurality of parallelizing techniques for a backward-propagation phase. The neural network training tool performs a backward-propagation phase of training the neural network using the selected backward-propagation parallelizing technique and the selected backward-propagation computation technique to generate error gradients and weight deltas and to update weights associated with one or more layers of the neural network.

### BACKGROUND

A convolution neural network (CNN) is a sub-class of artificial neural networks where neurons in a layer are only connected to neurons in the local surrounding in the previous layer, and weights are shared between the neurons. In order to determine weights at each of the layers, the CNN undergoes training using two separate phases. The first phase of the training is a forward-propagation phase, where activations at each layer of the CNN are calculated based on the activations and the weights of the previous layer. The second phase of the training is a backward-propagation phase, where error gradients and corrections to the weights are calculated. Additionally, during the backward-propagation phase, the weights at one or more of the layers are updated.

Training a CNN is computationally intensive. Further, properties of the CNN can impact performance and speed during training. For instance, based on both a number of features at each layer in the CNN and a sparsity of the data within the CNN, performance of a CNN can lack arithmetic intensity, which is a ratio of a number of arithmetic operations to a number of memory operations in a computation.

### SUMMARY

This disclosure describes a neural network training performance optimization framework. In some examples, during a forward-propagation phase of training, the framework determines a parallelizing technique a calculation technique for performing convolution when training the neural network using one or more inputs. In some examples, techniques for parallelizing can include parallel processing and processing in parallel. In some examples, forward-propagation calculating techniques for convolution can include matrix multiplication and stencil-based computation. In some examples, the framework determines parallelizing and computation techniques for the forward-propagation phase of training based on properties of the neural network and/or based on properties of data within the neural network.

Additionally or alternatively, the framework can select from multiple techniques for a backward-propagation phase of training the neural network. For instance, in some examples, the framework can determine whether to use parallel processing or processing in parallel. In some examples, the framework can further determine whether to use matrix multiplication or tiled sparse computation kernels for training the neural network during the backward-propagation phase. In some examples, the framework determines the parallelizing and computation techniques for performing backward-propagation based on properties of the neural network and/or based on properties of data within the neural network. The framework can then use the selected parallelization and computation techniques for backward-propagation to update weights for one or more layers of the neural network.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram illustrating an example environment for optimizing training of a neural network.

FIG. 2 is a block diagram illustrating an example data flow for performing the forward-propagation phase of training a neural network.

FIG. 3 is a block diagram illustrating an example data flow for performing the backward-propagation phase of training a neural network.

FIG. 4 is a graph that illustrates example criteria for selecting techniques to use for the forward-propagation phase and the backward-propagation phase of training a neural network.

FIG. 5 is a block diagram that illustrates parallel processing and processing in parallel.

FIGS. 6A-6B are block diagrams illustrating an example of forward-propagation matrix multiplication.

FIG. 7 is a code segment illustrating an example stencil computation kernel.

FIG. 8 is a block diagram that illustrates storing an example sparse matrix in Column Tiled-Compression Sparse Row (CT-CSR) format that can be used to perform sparse-dense matrix multiplication during the backward propagation phase of neural network training

FIG. 9 is a block diagram that illustrates example sparse matrix multiplication that can be used to perform sparse stencil code generation during training of a neural network.

FIG. 10 is a pictorial diagram that illustrates an example sparse kernel that can be used to perform error gradient calculations during training of a neural network.

FIG. 11 is a block diagram illustrating an example computing device configured to support a neural network training performance optimization framework.

FIG. 12 is a flow diagram of an example method for performing a forward-propagation phase of training a neural network.

FIG. 13 is a flow diagram of an example method for performing a backward-propagation phase of training a neural network.

### DETAILED DESCRIPTION

### Overview

Examples described herein provide a neural network training performance optimization framework. The framework can select one or more techniques to use for training a neural network with one or more inputs during both a forward-propagation phase of training and a backward-propagation phase of training. In some examples, the framework can select from multiple computation techniques to use when training the neural network during the forward-propagation phase of training. In some examples, a first computation technique includes forward-propagation (FP) matrix multiplication. FP matrix multiplication includes unfolding one or more matrices associated with an input, and performing matrix multiplication at each layer of the neural network based on the one or more unfolded matrices. Additionally, in some examples, a second computation technique for convolution includes processing inputs using stencil-based computations.

Additionally, the framework can select from multiple parallelizing techniques for training the neural network during the forward-propagation phase of training. In some examples, a first technique for parallelizing can include parallel processing. Parallel processing includes processing an individual input using two or more cores of a processor in parallel. For instance, parallel processing can include parallel matrix multiplication for FP matrix multiplication and parallel stencil computation for stencil-based computations. A second technique for parallelizing can include processing in parallel. Processing in parallel includes processing multiple individual inputs in parallel, each on a separate core of the processor. For instance, parallel processing can include matrix multiplication in parallel for FP matrix multiplication and stencil computing in parallel for stencil-based computations.

In some examples, the framework can use one or more properties associated with the neural network when selecting the parallelizing technique and/or the computation technique for convolution to use during the forward-propagation phase of training the neural network. Properties that can be used as selection criteria for selecting a forward-propagation computation technique can include, but are not limited to, for example, a number of layers within the neural network, a number of feature maps associated with individual layers of the neural network, a sparsity of the data associated with individual layers of the neural network, a stride size associated with the convolution, and a size associated with a convolution filter that is used to process the inputs. Additionally or alternatively, in some examples, the framework can further use one or more properties as selection criteria when selecting the parallelizing technique to use during the forward-propagation phase of training the neural network, including, but are not limited to, a size of the inputs, a number of inputs, a number of feature maps of the inputs, a stride size associated with the convolution, and a size associated with a convolution filter that is used to process the inputs.

In some examples, the framework can further determine computation and parallelization techniques to use for training the neural network during the backward-propagation phase of training. For instance, in some examples, a first backward-propagation computation technique can include backward-propagation (BP) matrix multiplication. BP matrix multiplication uses matrix multiplication on the error gradients and weights of a layer to calculate error gradients of the previous layer. The framework can then process the neural network using matrix multiplication of error gradients and input activations of each layer to compute weight deltas for updating the weights of the layer. In some examples, a second backward-propagation computation technique can include sparse-dense matrix multiplication. According to the sparse-dense matrix multiplication technique, sparse kernels use convolutions that are tiled based on sparse-dense matrix multiplication to calculate the weight deltas of a layer from the input activations and error gradients, and to calculate the error gradients of a layer from the weights and error gradients of the following layer. In an example implementation, computing error gradients, computing weight deltas, and updating weights for multiple inputs can be interleaved arbitrarily subject to the dependencies of weight updates on weight deltas.

The framework can further determine whether to use parallel processing or processing in parallel during the backward-propagation phase of training. Parallel processing can include, for example, parallel BP matrix multiplication or parallel sparse-dense matrix computations. Processing in parallel can include, for example, BP matrix multiplication in parallel or sparse-dense matrix computations in parallel.

In some examples, the framework can analyze one or more properties associated with the neural network when determining whether to use matrix multiplication or tiled kernels based on sparse-dense matrix multiplication during the backward-propagation phase of training. Example selection criteria for selecting a backward-propagation computation technique include, but are not limited to, a number of layers within the neural network, a number of feature maps associated with individual layers of the neural network, a sparsity of the data associated with individual layers of the neural network, and a size associated with a kernel that is used to process the inputs. Additionally, the framework can analyze one or more properties associated with the neural network when determining whether to use parallel processing or processing in parallel during the backward-propagation phase of training. Example selection criteria for choosing a backward-propagation parallelizing technique include, but are not limited to, a size of the inputs, a number of inputs, a number of feature maps of the inputs, and a size associated with a convolution filter that is used to process the inputs.

In some examples, the neural network can include more than one layer. In such examples, the framework can select forward-propagation and backward-propagation techniques, as described above, for each of the layers of the neural network. For instance, the framework can select a parallelizing technique and select a computation technique for convolution for each of the layers during the forward-propagation phase of training the neural network. Additionally, the framework can select a parallelizing technique and select a computation technique for each of the layers during the backward-propagation phase of training the neural network.

The framework described above can be useful when training different types of neural networks. For instance, the framework can optimize the training throughput of convolution neural networks (CNNs) due to the computationally intense nature of CNNs. In some examples, the framework optimizes the training of CNNs by increasing the arithmetic intensity of computations used to train the CNNS. For instance, by selecting from multiple techniques based on properties of the CNN and based on properties of the inputs, the framework can select techniques that not only optimize performance across the cores of a processor, but also elide computations that do not need to be performed (computations that include zero values) in order to train the CNN.

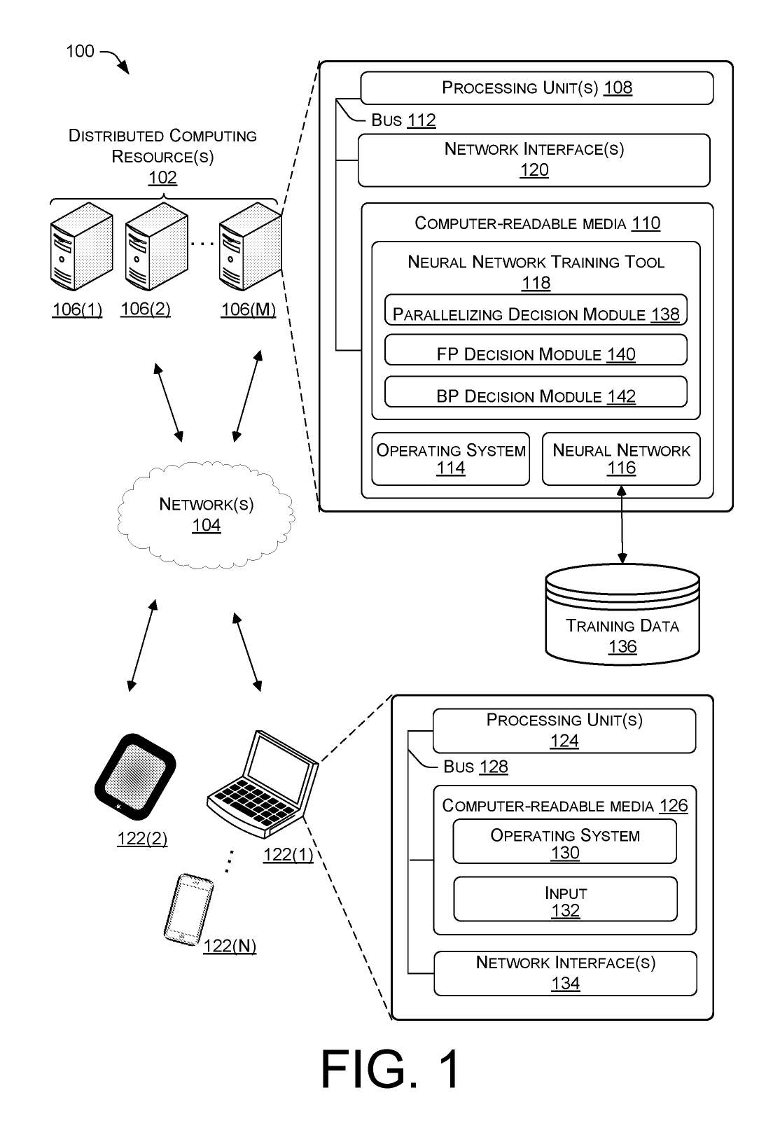

Various examples, scenarios, and aspects are described further with reference to FIGS. 1-13.

### Illustrative Environment

FIG. 1 shows an example environment 100 in which examples of a neural network performance optimization framework can operate. In some examples, the various devices and/or components of environment 100 include distributed computing resources 102 that can communicate with one another and with external devices via one or more networks 104.

Network(s) 104 can include, for example, public networks such as the Internet, private networks such as an institutional and/or personal intranet, or some combination of private and public networks. Network(s) 104 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 104 can utilize communications protocols, including packet-based and/or datagram-based protocols such as internet protocol (IP), transmission control protocol (TCP), user datagram protocol (UDP), or other types of protocols. Moreover, network(s) 104 can also include a number of devices that facilitate network communications and/or form a hardware basis for the networks, such as switches, routers, gateways, access points, firewalls, base stations, repeaters, backbone devices, and the like.

In some examples, network(s) 104 can further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various examples, distributed computing resources 102 include devices 106(1)-106(M). Examples support scenarios where device(s) 106 can include one or more computing devices that operate in a cluster or other grouped configuration to share resources, balance load, increase performance, provide fail-over support or redundancy, or for other purposes. Device(s) 106 can belong to a variety of categories or classes of devices such as traditional server-type devices, desktop computer-type devices, mobile-type devices, special purpose-type devices, embedded-type devices, and/or wearable-type devices. Thus, although illustrated as a single type of device, device(s) 106 can include a diverse variety of device types and are not limited to a particular type of device. Device(s) 106 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

Device(s) 106 can include any computing device having one or more processing unit(s) 108 operably connected to computer-readable media 110 such as via a bus 112, which in some instances can include one or more of a system bus, a data bus, an address bus, a PCI bus, a Mini-PCI bus, and any variety of local, peripheral, and/or independent buses. Executable instructions stored on computer-readable media 110 can include, for example, an operating system 114, neural network 116, neural network training tool 118, and other modules, programs, or applications that are loadable and executable by processing units(s) 108. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU embedded in an FPGA fabric.

Device(s) 106 can also include one or more network interfaces 120 to enable communications between computing device(s) 106 and other networked devices such as client computing device(s) 122. Such network interface(s) 120 can include one or more network interface controllers (NICs) or other types of transceiver devices to send and receive communications over a network. For simplicity, other components are omitted from the illustrated device(s) 106.

Other devices configured to implement a neural network performance optimization framework can include client computing devices, for example one or more of devices 122(1)-122(N). Device(s) 122 can belong to a variety of categories or classes of devices, which can be the same as, or different from, device(s) 106, such as traditional client-type devices, desktop computer-type devices, mobile-type devices, special purpose-type devices, embedded-type devices, and/or wearable-type devices. Client computing device(s) 122 can include, but are not limited to, a laptop computer 122(1), a tablet computer 122(2), telecommunication devices such as a mobile phone 122(N), computer navigation type client computing devices such as satellite-based navigation systems including global positioning system (GPS) devices and other satellite-based navigation system devices, a mobile phone/tablet hybrid, a personal data assistant (PDA), a personal computer, other mobile computers, wearable computers, implanted computing devices, desktop computers, automotive computers, network-enabled televisions, thin clients, terminals, game consoles, gaming devices, work stations, media players, personal video recorders (PVRs), set-top boxes, cameras, integrated components for inclusion in a computing device, appliances, or any other sort of computing device configured to access neural network 116.

Client computing device(s) 122 of the various categories or classes and device types such as the illustrated laptop computer 122(1) can represent any type of computing device having one or more processing unit(s) 124 operably connected to computer-readable media 126 such as via a bus 128, which in some instances can include one or more of a system bus, a data bus, an address bus, a PCI bus, a Mini-PCI bus, and any variety of local, peripheral, and/or independent buses.

Executable instructions stored on computer-readable media 126 can include, for example, an operating system 130, input 132, and other modules, programs, or applications that are loadable and executable by processing units(s) 124.

Client computing device(s) 122 can also include one or more network interfaces 134 to enable communications between client computing device(s) 122 and other networked devices, such as other client computing device(s) 122 or device(s) 106 over network(s) 104. Such network interface(s) 134 can include one or more network interface controllers (NICs) or other types of transceiver devices to send and receive communications over a network.

In the example of FIG. 1, device(s) 106 can use neural network training tool 118 to train one or more neural networks, such as neural network 116, using training data 136. Training data 136 can include one or more inputs, each having a known correct label, for training neural network 116. Inputs can include, but are not limited to, images, audio recordings, text, video recordings, or combinations thereof (e.g., text and images). In some examples, neural network training tool 118 trains neural network 116 by processing one or more inputs from training data 136 through neural network 116 during a forward-propagation phase of training. Neural network training tool 118 then uses outputs from the forward-propagation phase of training to determine error gradients and weight deltas during a backward-propagation phase of training. Additionally, during the backward-propagation phase of training, neural network training tool 118 updates weights of one or more layers of neural network 116 using the weight deltas.

FIG. 1 illustrates an example in which training data 136 is stored separately from device(s) 106. In such an example, device(s) 106 can receive training data 136 over a network, such as network(s) 104. In an alternate embodiment, training data 136 may be stored in computer-readable media 110 of device(s) 106.

While training neural network 116 using training data 136, neural network training tool 118 can use parallelizing decision module 138, forward-propagation (FP) decision module 140, and backward-propagation (BP) decision module 142 to select from a plurality of different techniques for processing training data 136 during the forward-propagation phase and/or the backward-propagation phase of training neural network 116. For example, neural network training tool 118 can use parallelizing decision module 138 to determine whether to use parallel processing or processing in parallel at each layer of neural network 116 during the forward-propagation phase of training and during the backward-propagation phase of training. Additionally, neural network training tool 118 can use FP decision module 140 to determine whether to use matrix multiplication or stencil-based computation at each layer of neural network 116 during the forward-propagation phase of training. Moreover, neural network training tool 118 can use BP decision module 142 to determine whether to use matrix multiplication or sparse-dense matrix computation at each layer of neural network 116 during the backward-propagation phase of training.

As illustrated in FIG. 1, computer-readable media 126 of device(s) 120 may include input 132. Input 132 can represent, for example, a single input to be processed by neural network 116. For instance, input 132 can include an image, text, an audio clip, a video clip, or any combination thereof, to be processed by neural network 116. In some examples, device(s) 122 send input 132 to device(s) 106 over network(s) 104. In response, device(s) 106 use neural network 116 to process input 132 and send an output associated with processing input 132 to device(s) 120 over network(s) 104. As such, during and/or after training neural network 116, device(s) 106 can receive inputs from other network devices and process the inputs using neural network 116.

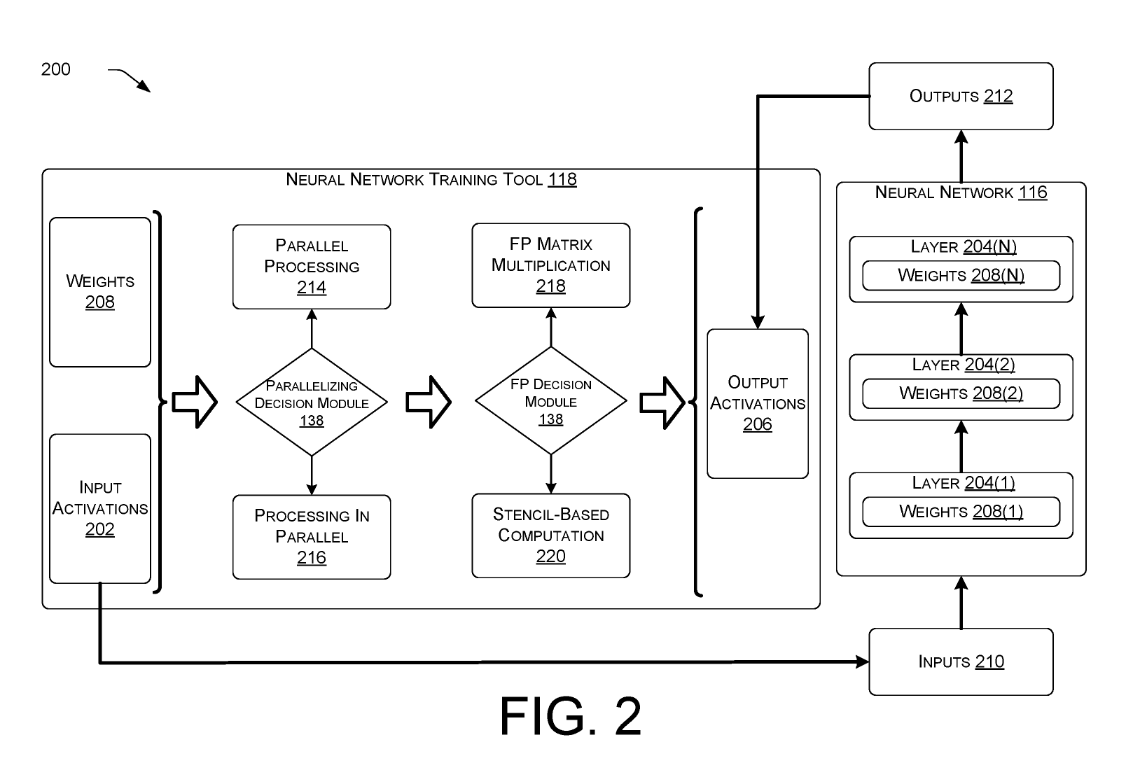

FIG. 2 illustrates an example data flow 200 for the forward-propagation phase of training a neural network. During the forward-propagation phase of training, neural network training tool 118 trains neural network 116 using input activations 202. Input activations 202 correspond to each of the inputs that are processed by the layers 204 of the neural network 116 in order to generate output activations 206 for the layers 204. To process the input activations 202 at each of the layers 204, each of the layers 204 processes the respective input activation 206 for the layer 206 using the respective weights 208 for that layer 204.

For instance, in the example of FIG. 2, inputs 210 can include the first input activation 202 that is processed by layer 204(1) in order to generate a first of output activations 206. To process the first input activation 202, the neural network 116 uses the weights 208(1) of the first layer 204(2) to process the first input activation 202 in order to generate a first output activation 206 for the first layer 204(1). Next, the neural network 116 uses the first output activation 206 of the first layer 204(2) as the second input activation 202 for the second layer 204(2). The neural network 116 can process the second input activation 202 using the weights 208(2) of the second layer 204(2) in order to generate a second output activation 206. The neural network 116 can then continue processing each of the layers 204 using the described method until the input activation 202 of the last layer 204(N) of the neural network 116 is processed using weights 208(N) of the last layer 204(N) in order to generate outputs 212. In the example of FIG. 2, outputs 212 corresponds to the final output activation 206 of the neural network 116.

For example, inputs 210 can include one or more inputs from training data 136 of FIG. 1. For instance, inputs 210 can include one or more images, audio recordings, text, video recordings, and/or combinations thereof. As such, to train neural network 116, neural network training tool 118 provides one or more inputs 210 to neural network 116. Neural network 116 processes the received inputs 210 and generates outputs 212. In some examples, each output 212 corresponds to one input 210.

For example, neural network training tool 118 can train neural network 116 to perform a task. In some examples, neural network training tool 118 can train neural network 116 to perform image recognition, speech recognition, handwriting recognition, pattern recognition, image captioning, text analysis and summarization, or any other task that a neural network 116 can perform. As such, each output 212 from neural network 116 represents a result of an analysis of a corresponding input 210 processed by neural network 116.

For example, if neural network training tool 118 is training neural network 116 to perform image recognition, an input 210 may include an image of a car and the corresponding output 212 may include a result that indicates that the image is an image of a car. For another example, if neural network training tool 118 is training neural network 116 to perform handwriting recognition, an input 210 may include a handwritten word that spells “cat” and the corresponding output 212 may include an analysis result that indicates that the handwritten word spells “cat”. However, since neural network training tool 118 is training neural network 116 using inputs 210, analysis of a particular input 210 may generate an incorrect result as a corresponding output 212. That is, for example, an input for a handwriting recognition neural network may be a handwritten word “cat”, and the output may indicate that the neural network identified the word “cot.” As such, neural network training tool 118 trains neural network 116 by updating one or more weights 208 within each of layers 204 based on inputs 210 and outputs 212, improving the accuracy of the neural network.

In the example of FIG. 2, neural network training tool 118 can train neural network 116 using various combinations of different techniques. For instance, during the forward-propagation phase of training, neural network 116 processes each of the input activations 202 using cores of one or more processors. As such, in some examples, neural network training tool 118 can use parallelizing decision module 138 to select from multiple techniques for parallelizing the processing of input activations 202 using the different cores of the one or more processors. In some examples, techniques for parallelizing input activations 202 using multiple cores of a processor can include parallel processing 214 and processing in parallel 216.

Parallel processing 214 includes processing a single input activation 202 using two or more cores of a processor. For instance, if a processor includes eight different cores, parallel processing 214 can cause neural network 116 to process a single input activation 202 using two or more of the eight cores in parallel. In some examples, processing a single input activation 202 across multiple cores can include performing different arithmetic operations associated with the single input activation 202 on each of the multiple cores, in parallel. For example, parallel processing 214 can include parallel matrix multiplication when FP matrix multiplication 218 is selected and parallel stencil-based computation when stencil-based computation technique 220 is selected.

In contrast, processing in parallel 216 includes processing multiple input activations 202 in parallel, where each one of the multiple input activations 202 is processed using a single core of a processor. For instance, if a processor includes eight different cores, processing in parallel 216 can include processing eight different input activations 202 in parallel, where each of the eight input activations 202 is processed using one of the eight cores. In some examples, processing each of the eight input activations 202 using one of the eight cores can include performing all of the arithmetic operations for a single input activation 202 using a single core. For instance, processing in parallel 216 can include matrix multiplication in parallel when FP matrix multiplication 218 is selected and stencil-based computation in parallel when stencil-based computation technique 220 is selected.

Additionally or alternatively, in some examples, neural network training tool 118 can use forward-propagation decision module 140 to select from multiple computation techniques for computing convolution operations when processing input activations 202. For example, computation techniques for computing convolution operations can include forward-propagation (FP) matrix multiplication 214 and stencil-based computation technique 220.

FP matrix multiplication 218 computes convolutions using matrix multiplication in a two-step process. For example, a convolution operation in two dimensions can be represented using a 5-tuple convolution kernel:

[symbol]

N_{f}, F_{y}, Fₓ, s_{y}, sₓ [symbol] (1)

The convolution computation can then mathematically be written as:

$$O [ f , y , x ] = {\sum }_{c , {k}_{y} , {k}_{x} = 0}^{{N}_{c} , {F}_{y} , {F}_{x}} I [ c , y * {s}_{y} + {k}_{y} , x * {s}_{x} + {k}_{x} ] \times W [ f , c , {k}_{y} , {k}_{x} ] \qquad ( 2 )$$

Where O and I represent the output activations 206 (i.e., features associated with individual outputs 212) and input activations 202 (i.e., features associated with individual inputs 210), respectively, W represents the weights 208 between layers of neural network 116, y and x are the spatial coordinates of the output activation (i.e., the (x,y) coordinates in two-dimensional space), f represents the features of the output activations, c represents the features of the input activations, s_{y} and sₓ are the strides along the y and x dimensions, and k_{y} and kₓ represent the kernel coordinates (weights corresponding to connections that are a distance of k_{y} and kₓ from the output neuron along y and x dimensions). Additionally, in equations (1) and (2) above, N_{f} represents the number of output features, N_{c} represents the number of input features, F_{y} represents the kernel width along the y dimension, and Fₓ represents the kernel width along the x dimension.

Using equation (2) above, in a first step of FP matrix multiplication 218, input activations 202 are unfolded into matrices that acts as input in the second step. In the second step of FP matrix multiplication 218, matrix multiplication is performed on the matrices in order to compute the output activations 206.

Stencil-based computation technique 220 avoids the arithmetic intensity of unfolding input activation matrices. For example, according to stencil-based computation technique 220 each output element is updated based on the neighboring input values that are specified by a stencil. This allows for spatial reuse, where each input value is only loaded once into fast memory and is used multiple times before it is discarded.

Stencil-based computation technique 220 uses stencil-based computations as a building block for generating efficient vector code. In some examples, the vector code consists of a basic block generator and a schedule generator. The basic block generator generates register tiled vector instructions to improve the reuse of each input vector load and to reduce the total number of load instructions. The schedule generator tiles the computation blocks produced by the basic block generators to optimize cache locality.

In some examples, neural network training tool 118 can use both parallelizing decision module 138 and forward-propagation decision module 140 to determine techniques to use for processing input activations 202 at each layer 204 of neural network 116. For instance, neural network training tool 118 can use parallelizing decision module 138 to determine whether to use parallel processing 214 or processing in parallel 216 for layer 204(1) of neural network 116, and can use forward-propagation decision module 140 to determine whether to use FP matrix multiplication 218 or stencil-based computation technique 220 for layer 204(1) of neural network 116. Neural network training tool 118 can then use parallelizing decision module 138 to determine whether to use parallel processing 214 or processing in parallel 216 for layer 204(2) of neural network 116, and can use forward-propagation decision module 140 to determine whether to use FP matrix multiplication 218 or stencil-based computation technique 220 for layer 204(2) of neural network 116.

In some examples, neural network training tool 118 determines which techniques to use based on properties associated with neural network 116. For instance, properties associated with neural network 116 can include, but are not limited to, a number of layers 204 within neural network 116, a number of feature maps associated with individual layers 204 of neural network 116, a sparsity of data within individual layers 204 of neural network 116, a stride size associated with the convolution, and a size associated with a convolution filter that is used to process input activations 202. Additionally or alternatively, in some examples, neural network training tool 118 determines which techniques to use based on properties associated with input activations 202. For instance, properties associated with input activations 202 can include a size of individual input activations 202 and a number of input activations 202.

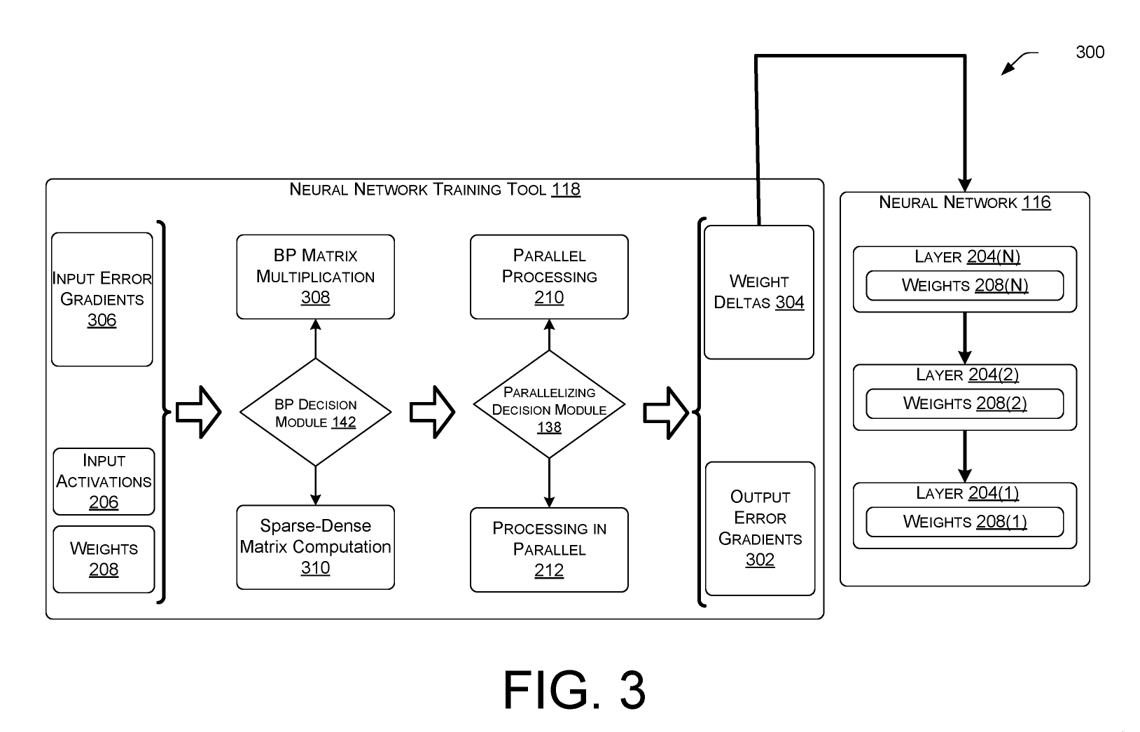

FIG. 3 illustrates an example data flow 300 for the backward-propagation phase of training a neural network. During backward-propagation, neural network training tool 118 calculates output error gradients 302 and weight deltas 304. Neural network training tool 118 can then use the weight deltas 304 to update weights 208 within neural network 116.

For example, neural network training tool 118 can compute output error gradients 302 according to:

$${E}_{I} [ c , y , x ] = {\sum }_{f , {k}_{y} , {k}_{x} = 0}^{{N}_{c} , {F}_{y} , {F}_{x}} {E}_{O} [ f , \frac{y - {k}_{y}}{{s}_{y}} , \frac{x - {k}_{x}}{{s}_{x}} ] \times W [ f , c , {k}_{y} , {k}_{x} ] \qquad ( 3 )$$

Where E_{I} represents errors in the input activations 206 based on input error gradients (E_{O}) 306. Input activations 206 to the backward-propagation phase correspond to the output activations 206 generated in the forward-propagation phase illustrated in FIG. 2. Using the example of FIG. 2, input error gradients 306 can represent the difference between an expected output for an input 210 and an actual output 212 for that input 210. For example, if the expected output for an input 210 is the word “cat,” and the actual output 212 for the input is the word “cot,” then the input error gradient 306 for that input 210 would be the difference between “cat” and “cot”.

Additionally, neural network training tool 118 can compute weight deltas 304 according to:

dW[f,c,k_{y},kₓ]=Σ_{y,x=0}^{N}^{_{y}}^{,N}^{ₓ}E_{O}[f,y,x]×I[c,y*s_{y}+k_{y},x*sₓ+kₓ] (4)

Where dW represents weight deltas 304 and I represents input activations 308. Additionally, N_{y} and Nₓ represent the spatial size of the output activations along the y and x dimensions, respectively.

In order to utilize the above calculations for the backward-propagation phase of training, neural network training tool 118 uses BP decision module 142 to select one of multiple computation techniques for performing the backward-propagation phase. In some examples, the computation techniques for performing the backward-propagation phase can include backward-propagation (BP) matrix multiplication 308 and a sparse-dense matrix computation technique 310.

According to BP matrix multiplication 308, neural network training tool 118 performs operations similar to those described above with referenced to FP matrix multiplication 218, but in a reverse order. For example, when applying BP matrix multiplication 308, neural network training tool 118 computes output error gradients 302 of a layer using input error gradients and weights 314 of an above layer in an unfolded form, where weights 314 correspond to weights 208.

According to BP matrix multiplication 308, neural network training tool 118 can then calculate the weight deltas 304 for neural network 116 by performing matrix multiplication on the input error gradients 306 and the input activations 308.

In contrast, sparse-dense matrix computation technique 310 utilizes a sparsity associated with the error gradients to calculate output error gradients 302 and weight deltas 304. For example, according to sparse-dense matrix computation technique 310, neural network training tool 118 uses input error gradients 306 as a first input and either input activations 308 or weights 314 as a second input for calculating output error gradients 302 and weight deltas 304. In some examples, input error gradients 306 are represented as a sparse matrix. In some examples, sparse-dense matrix computation technique 310 keeps the second input dense when calculating output error gradients 302 and weight deltas 304.

For example, sparse-dense computation technique 310 can use a Column Tiled-Compressed Sparse Row (CT-CSR) format for storing sparse matrices in a Compressed Sparse Row format. A sparse kernel can then use the sparse matrices to perform matrix-matrix multiplication when calculating the output error gradient 302 and weight deltas 304.

Also illustrated in the example of FIG. 3, neural network training tool 118 uses parallelizing decision module 138 to determine whether to use parallel processing 214 or processing in parallel 216 during the backward-propagation phase. During the backward-propagation phase, parallel processing 214 can include performing parallel matrix multiplication when BP matrix multiplication 308 is selected and using parallel sparse-dense matrix computation when sparse-dense matrix computation technique 310 is selected. Processing in parallel can include performing matrix multiplication in parallel when BP matrix multiplication 308 is selected and performing sparse-dense matrix computations in parallel when sparse-dense matrix computation technique 310 is selected.

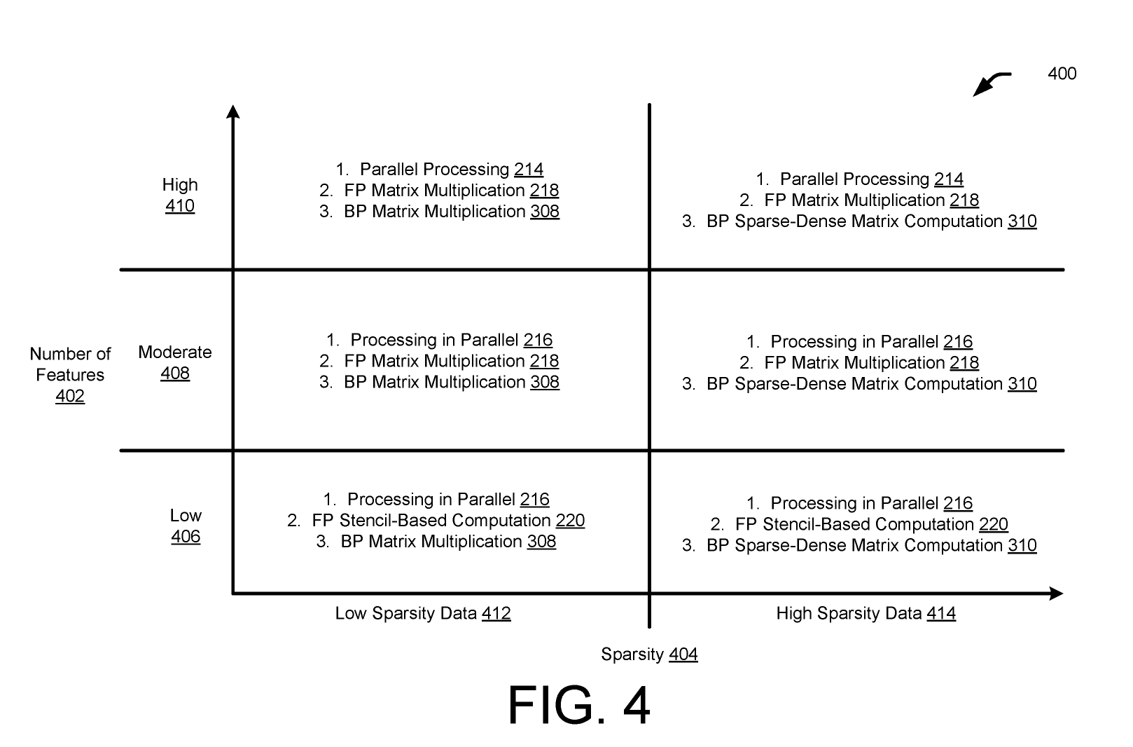

FIG. 4 illustrates an example graph for analyzing properties of the neural network and properties of the data inputs to select techniques to use for both the forward-propagation phase and the backward-propagation phase of training a neural network. As illustrated in the example of FIG. 4, selecting computation and parallelizing techniques to use for training the neural network can be based on both a number of features 402 in the neural network and data sparsity 404 within the neural network. In the example of FIG. 4, for each area of the graph, (1) represents a parallelization technique, which may be used for both the forward-propagation phase and the backward-propagation phase, (2) represents a forward-propagation computation technique, and (3) represents a backward-propagation computation technique.

Number of features 402 can include the number of features that a neural network includes at each of the layers of the neural network. For instance, neural network 116 may include fifty features at a first layer 204(1) and one hundred features at a second layer 204(2). As illustrated in FIG. 4, determining which techniques to use for training a neural network can be based on whether the neural network includes a low number of features 406, a moderate number of features 408, or a high number of features 410. In some examples, each of the standards for what is considered a low number of features 406, moderate number of features 408, and high number of features 410 can be based on the neural network, and thresholds can be set to define each standard.

For example, for a given neural network, a first threshold number of features may be used to determine whether there is a low number of features 406 at a given level within a neural network. In some examples, the first threshold number of features can include a specific number of features, such as 128 features. In some examples, the first threshold number of features can be based on properties associated with the neural network. For instance, the properties associated with the neural network can include the type of neural network, a size of the neural network, and a number of layers within the neural network. Still, in some examples, the first threshold number of features can be based on properties associated with a device (such as one of device(s) 106 from FIG. 1) that is training the neural network. For instance, the properties associated with the device can include hardware constraints of the device, such as a size of the computer-readable media, a number of processors on the device, and/or a number of cores per processor on the device. In each of the examples, a neural network training tool can determine that there is a low number of features 406 at a given layer of the neural network when the number of features at the given layer is less than the first threshold.

In some examples, a second threshold number of features may be used to determine whether there is a moderate number of features 408 and/or a high number of features 410 at a given level within a neural network. In some examples, the second threshold number of features can include a specific number of features, such as 1024 features. In some examples, the second threshold number of features can be based on properties associated with the neural network. Still, in some examples, the second threshold number of features can be based on properties associated with a device (such as one of device(s) 106 from FIG. 1) that is training the neural network. In each of the examples, a neural network training tool can determine that there is a moderate number of features 408 at a given layer of the neural network when the number of features at the given layer is less than the second threshold. Additionally, the neural network training tool can determine that there is a high number of features 410 at a given layer of the neural network when the number of features at the given layer is equal to or greater than the second threshold.

Sparsity 404 can be defined as the ratio of elements in a data array at a given level that include zero values. As illustrated in FIG. 4, determining which techniques to use for training a neural network can be based on whether the neural network includes a low sparsity data 412 or a high sparsity data 414. In some examples, a neural network training tool determines whether a given layer of a neural network includes a low sparsity data 412 or a high sparsity data 414 based on a threshold percentage of elements within the given layer that include zero values. For instance, the neural network training tool can determine that layers with more than 75% sparsity are high sparsity data 414 layers, while layers with 75% or less sparsity are low sparsity data 412 layers. In some examples, the neural network training tool determines the threshold percentage for data sparsity 404 based on properties associated with the neural network and/or properties associated with a device (such as one of device(s) 106 from FIG. 1) that is training the neural network.

In the example of FIG. 4, a neural network training tool may select parallel processing 214 when there is a high number of features 410 and may select processing in parallel 216 when there is either a moderate number of features 408 or a low number of features 406. The selection criteria is based on an observation that the arithmetic intensity (ratio of the number of arithmetic operations to the number of memory operations) per computation is high when there is a high number of features 410, moderate when there is a moderate number of features 408, and low when there is a low number of features 406. When computations are split between the cores of a processor, performance per core decreases as the arithmetic intensity decreases.

Additionally, in the example of FIG. 4, a neural network training tool may determine to use FP matrix multiplication 218 when there is a high number of features 410 or a moderate number of features 408, and FP stencil-based computation 220 when there is a low number of features 406. The selection criteria is based on an observation that unfolding of matrices during FP matrix multiplication 218 reduces the arithmetic intensity by both increasing the number of loading and storing operations and increasing the size of the input activation used for convolution. As such, for layers of a neural network that include a low number of features 406, stencil-based computation 220 increases the arithmetic intensity.

Moreover, in the example of FIG. 4, a neural network training tool may determine to use BP matrix multiplication 308 when there is low sparsity data 412 and sparse-dense matrix computation 310 when there is high sparsity data 414. The selection criteria is based on an observation that BP matrix multiplication 308 will perform many computationally intensive operations, even when the data includes zero values. In contrast, as discussed above, sparse-dense matrix computation technique 310 will prevent the neural network training tool from performing computational intensive operations for data with zero values.

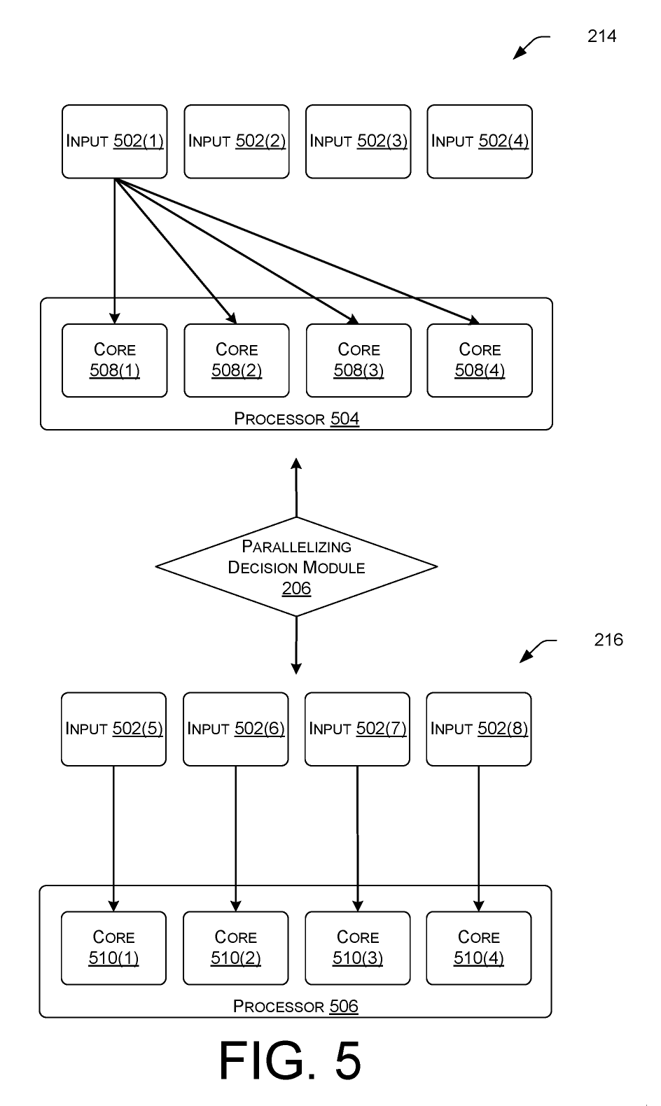

FIG. 5 illustrates parallel processing 214 and processing in parallel 216, which may be used during the forward-propagation phase of training and/or during the backward-propagation phase of training. The description of FIG. 5 is given with regard to the forward-propagation phase of training, however, parallel processing 214 and processing in parallel 216 can also be used in the backward-propagation phase of training.

In the example of FIG. 5, inputs 502, which can represent inputs 210, are processed within a neural network using processors 504 and 506, which can represent processing unit(s) 108 from FIG. 1. For instance, inputs 502(1), 502(2), 502(3), and 502(4) are being processed on processor 504 using parallel processing 214, and inputs 502(5), 502(6), 502(7) and 502(8) are being processed on processor 506 using processing in parallel 216.

Using parallel processing 214, individual inputs 502(1), 502(2), 502(3), and 502(4) are each processed using two or more of the cores 508 of processor 504. For instance, in the example of FIG. 5, a neural network is utilizing parallel processing 214 to process input 502(1) using each of the four cores 508(1), 508(2), 508(3), and 508(4) of processor 504 in parallel. To process input 502(1) using cores 508(1), 508(2), 508(3) and 508(4), computations for processing input 502(1) are divided and performed in parallel using cores 508(1), 508(2), 508(3) and 508(4). In some examples, after processing input 508(1), each of inputs 502(2), 502(3) and 502(4) are processed similarly to input 502(1).

In contrast, using processing in parallel 216, individual inputs 502(5), 502(6), 502(7), and 502(8) are each processed using respective individual cores 510 of processor 506. For instance, in the example of FIG. 5, a neural network utilizes processing in parallel 216 to process input 502(5) on core 510(1), input 502(6) on core 510(2), input 502(7) on core 510(3), and input 502(8) on core 510(4), in parallel. For instance, computations for processing input 502(5) are performed by core 510(1), computations for processing input 502(6) are performed by core 510(2), computations for processing input 502(7) are performed by core 510(3), and computations for processing input 502(8) are performed by core 510(4).

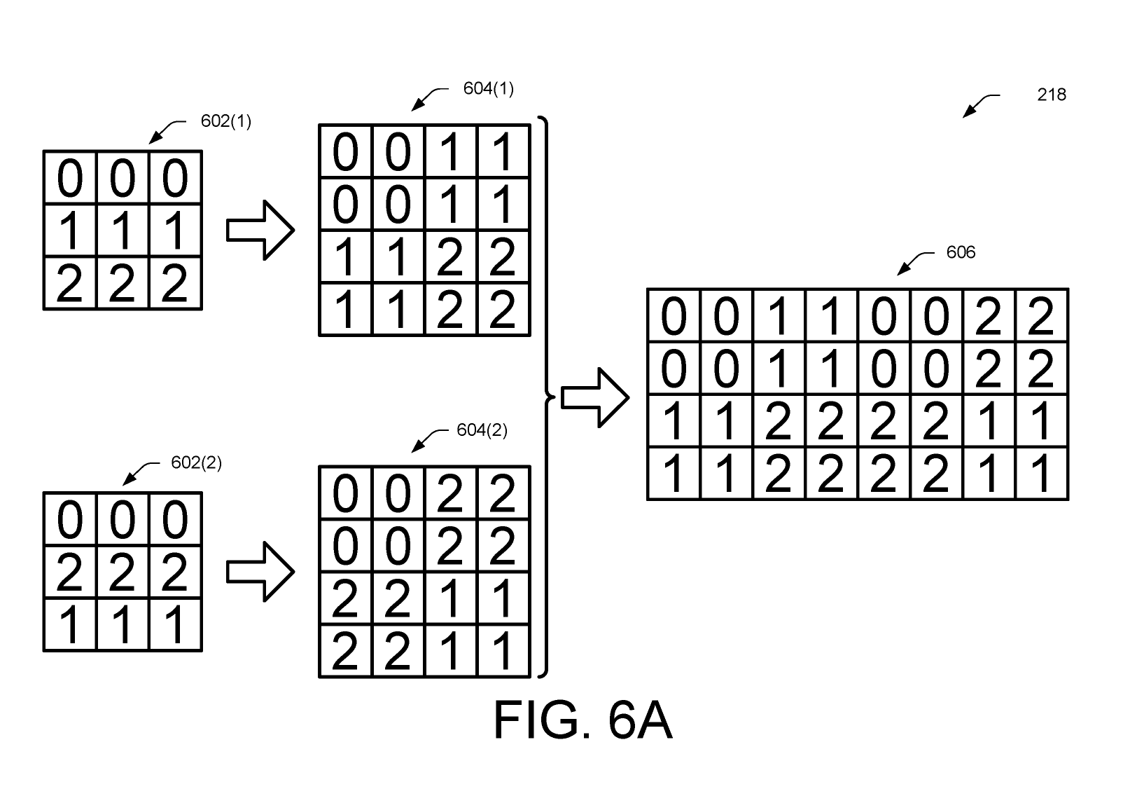

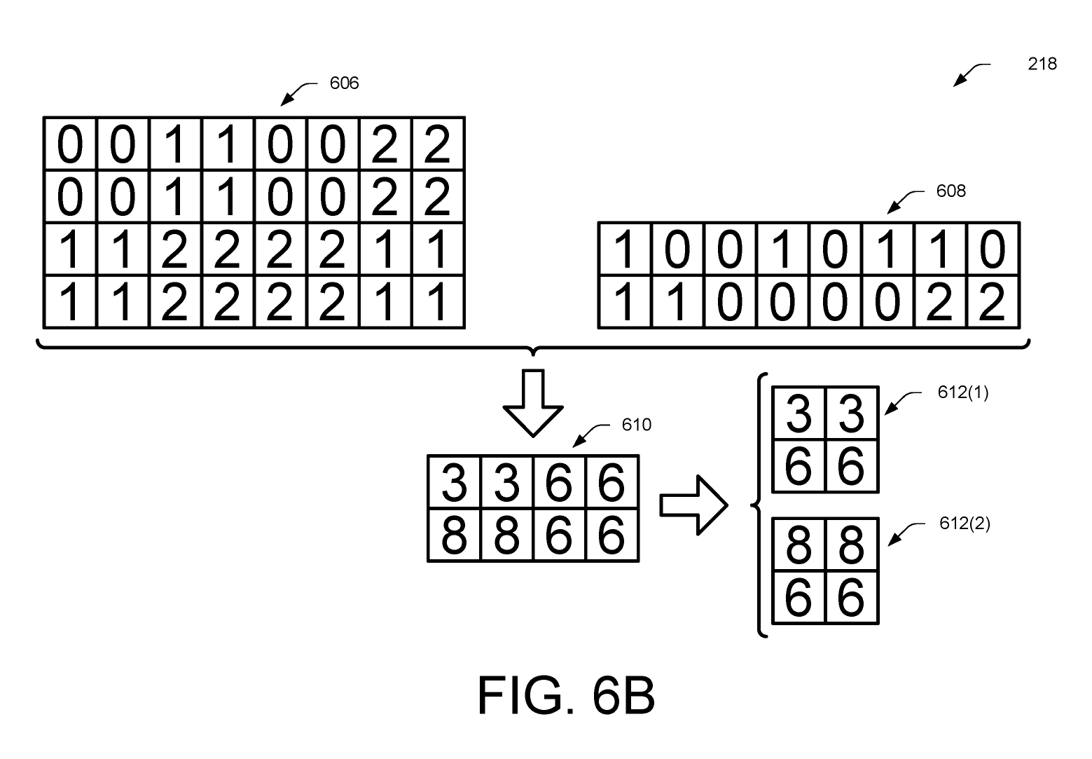

FIGS. 6A-6B illustrate an example of performing forward-propagation (FP) matrix multiplication 218. As discussed above, in a first step of FP matrix multiplication 218, input activations are unfolded into a matrix that serves as input to the second step.

For example, in the example of FIG. 6A, input activations 602(1) and 602(2) from an input (such as one of inputs 210 from FIG. 2) are unfolded to generate unfolded input activations 604(1) and 604(2), respectively. In some examples, input activations 602(1) and 602(2) can include an array of floating results from the input. For instance, input activations 602(1) and 602(2) can represent two color channels of the input. In the example of FIG. 6A, input activation 602(1) can represent the red color channel and input activation 602(2) can represent the blue color channel of an image (i.e., the input). The two unfolded input activations 604(1) and 604(2) are then combined to generate unfolded input matrix 606.

For example, unfolding the input activations 602 can transform I[c, y′, x′] into U[yx, ck_{y}kₓ] by the following computation:

U[yx,ck_{y}kₓ]=I[c,y′*s_{y}+k_{y},x′*sₓ+kₓ] (5)

Where yx=y*Nₓ+x, ck_{y}=c*F_{y}*Fₓ+k_{y}*Fₓ+kₓ, I[ ] represents the original input, U[ ] represents the unfolded input, k represents the convolution filter (kernel), x represents the convolution filter (kernel) width, y represents the convolution filter (kernel) height, x′ represents the input width, y′ represents the input height, and s represents the stride size. In the equation above, each row (r) of the unfolded matrix represents elements used to compute an output element (x, y), such that:

y*Nₓ+x==r (6)

In the second step of FP matrix multiplication 218, the convolutions are computed using the unfolded input matrix and weights at a given layer. For instance, in the example of FIG. 6B, matrix multiplication is performed between unfolded input matrix 606 and weights 608 to compute output activations 610. Output activations 610 can then be split into output activations 612(1) and 612((2), where output activation 612(1) corresponds to input activation 602(1) and output activation 612(2) corresponds to input activation 602(2).

For example, the convolution equation (2) above can then be rewritten and computed as a matrix multiplication equation for FP matrix multiplication 218 in terms of U and W as:

O[f,y,x]=Σ_{ck}_{_{y}}ₖ_{ₓ}W[f, ck_{y}kₓ]×U[yx, ck_{y}kₓ] (7)

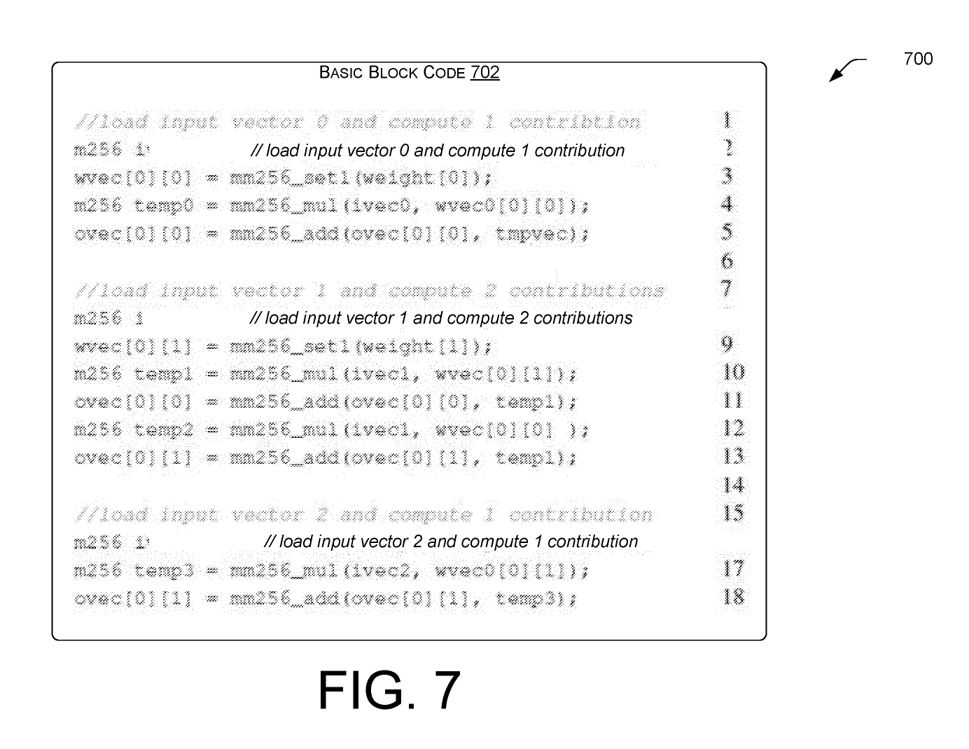

FIG. 7 illustrates an example stencil computation kernel 700. As discussed above, stencil-based computation technique 220 is a convolution computation technique that does not include unfolding matrices. In stencil computation kernel 700, each element of an array is updated based on neighboring values specified by a stencil. For instance, a three point stencil in one-dimension can be represented as:

A[x]=W₀A[x]+W₁A[x+1]+W₂A[x+2] (8)

Where each element A of the stencil, which represents a generic input array, is used to compute three different elements. For instance, A[x+2] is used to compute A[x], A[x+1], and A[x+2]. As such, stencil computation kernel 700 can utilize spatial reuse, which allows each element to be loaded once into fast memory and used multiple times before being discarded. For instance, each input activation 202 of an input 210 can be used to compute multiple output activations 206.

According to stencil-based computation technique 220, convolutions are first connected using stencil computations. For example, stencil computations can be computed by:

$$\begin{matrix}O [ f , y , x ] = {\sum }_{c , {k}_{y} {k}_{x}} I [ c , y + ky , x + kx ] \times W [ f , c , ky , kx ] & ( 9 ) \\ = {\sum }_{c} ( {\sum }_{kykx} I [ c , y + ky , x + kx ] \times W [ f , c , ky , kx ] ) & ( 10 ) \\ = {\sum }_{c} ( S [ f , c , y , x ] ) & ( 11 )\end{matrix}$$

In some examples, for a given y, x, c, and f, the computation inside the parenthesis of equation (11) can include a two dimensional fₓ×F_{y} point stencil operation. As such, S[f, c, y, x] represents the result of the stencil operation.

Stencil-based computation technique 220 uses stencil-based computations as a building block for generating efficient vector code. In some examples, the vector code consists of a basic block generator and a schedule generator. The basic block generator generates register tiled vector instructions to improve the reuse of each input vector load and to reduce the total number of load instructions. The schedule generator tiles the computation blocks produced by the basic block generators to optimize cache locality.

For instance, in the example of FIG. 7, basic block code 702 represents a stencil with a register tile size of rₓ=1 and r_{y}=2. For an output vector register tile with width rₓ and height r_{y}, basic block code 702 identifies the input vectors that contribute to the tile. For each input vector, basic block code 702 then generates instructions for loading the respective input vector, and for computing its contributions to the output vectors in the register tile. For instance, in vector block code 702, loading vector ivec[0][0] contributed to one output vector ovec[0][0] in the register tile, while loading of ivec1 contributes to two vectors ovec[0][0] and ovec[0][1] in the output register tile. Therefore, in the example of FIG. 7, ivec1 is loaded once, but used twice.

In some examples, the shape and/or size of the register tile can change over the reuse of each input vector load. In some examples, the size of rₓ and r_{y} are chosen such that rₓr_{y}≦the number of physical vector registers, and the number of load instructions is minimized. In some examples, stencil kernel code generation 216 determines an optimal size for rₓ and r_{y} by iterating over all possible values of rₓ and r_{y} based on rₓr_{y}≦the number of physical vector registers.

In some examples, stencil-based computation technique 220 can further perform data-layout transformation in order to generate a required input contiguous in memory for effective vectorization. For instance, for a given stride sₓ, the layout of the input is transformed by:

I[f,y,x]→I[f,y,s,x′] (12)

Such that s=x mod sₓ, x′=x/sₓ, and

$$\frac{{N}_{x}}{{S}_{x}} s + {x}^{′} = x ,$$

where Nₓ is the size of the x dimension.

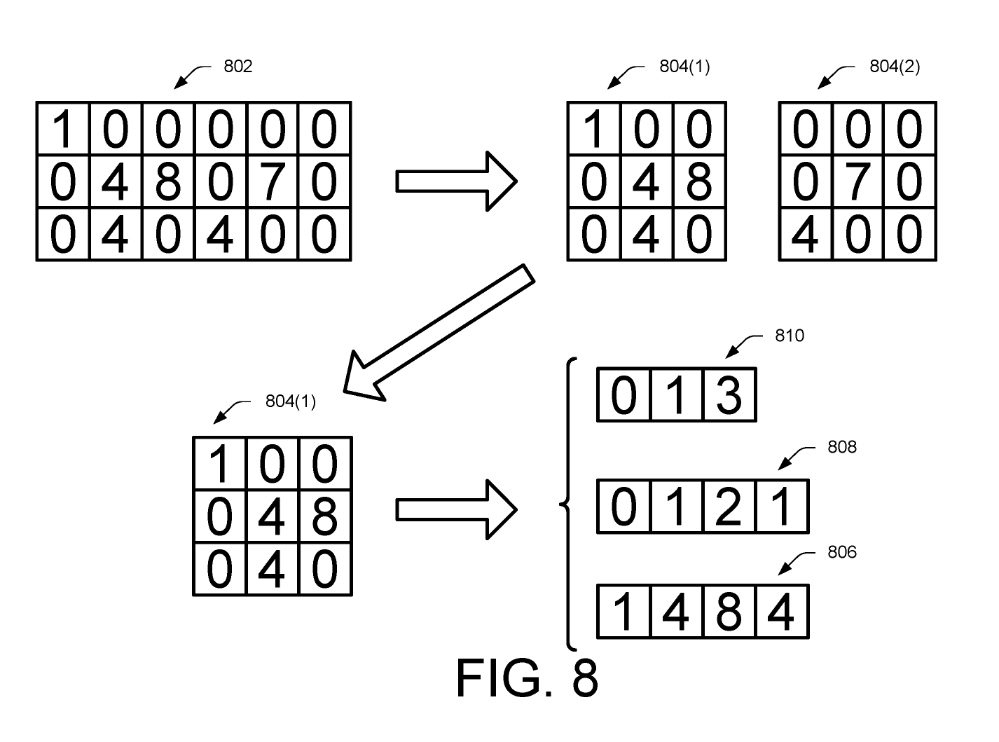

FIG. 8 illustrates storing an example sparse matrix in Column Tiled-Compression Sparse Row (CT-CSR) format that can be used to perform sparse-dense matrix multiplication during the backward-propagation phase of training a neural network. For instance, to store sparse matrix 802, sparse matrix 802 is tiled along the columns to generate a first Compressed Sparse Row (CSR) 804(1) and a second CSR 804(2). The first CSR 804(1) is stored using three arrays. In the example of FIG. 8, the three arrays include a value array 806 that stores non-zero values, a column index array 808 that stores column indices of the non-zero values, and a row index array 810 that stores, for each row in the value array 806, the corresponding position of the first non-zero value for that row, as found in the column index array 808. In some examples, a similar procedure is performed for storing the second CSR 804(2).

For example, the value array 806 includes each of the non-zero values found in CSR 804(1). Column index array 808 indicates that the first value in the value array 806 is found in column 0 of CSR 804(1), the second value in the value array 806 is found in column 1 of CSR 804(1), the third value in the value array 806 is found in column 2 of CSR 804(1), and the fourth value in the value array 806 is found in column 1 of CSR 804(1). Similarly, row index array 810 indicates the rows of the CSR 804(1) to which the values in the value array 806 correspond. Specifically, row index array 810 indicates that the first non-zero value in the first row in CSR 804(1) is the value at position 0 in value array 806, the first non-zero value in the second row in CSR 804(1) is the value at position 1 in value array 806, and the first non-zero value in the third row in CSR 804(1) is the value at position 3 in value array 806.

In some examples, the second CSR 804(2) can be stored using a similar approach as the first CSR 804(1). However, since the first row of the second CSR 804(2) includes all zero values, a sentinel value (e.g., −1) is used in the row index array to indicate that a particular value does not include any non-zero values.

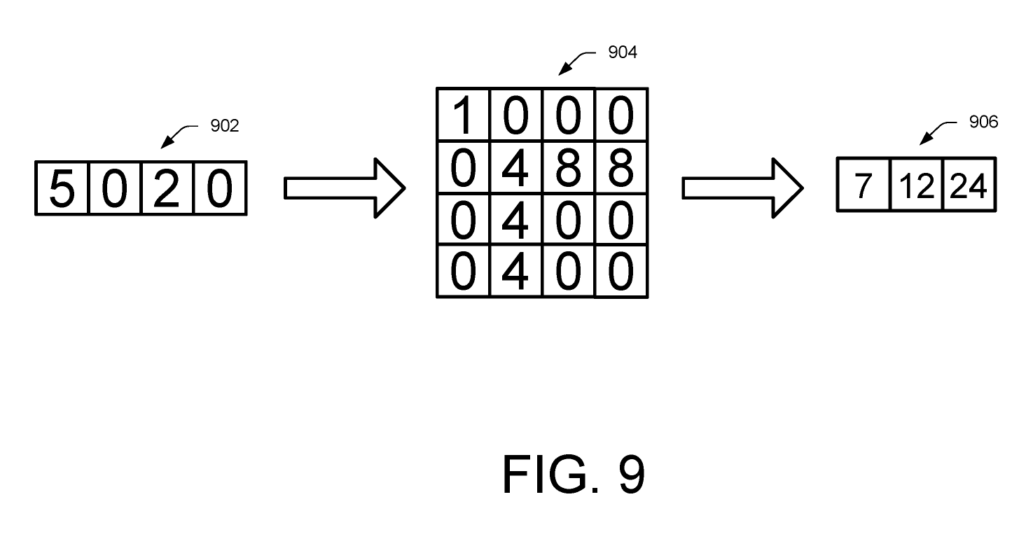

FIG. 9 illustrates an example of sparse matrix multiplication that can be used to perform sparse-dense matrix computation technique 310 during training of a neural network. In the example of FIG. 9, matrix multiplication is performed between a sparse column matrix 902 (e.g., output activation errors of features) and a dense matrix 904 (e.g., weights for different channels of a feature) in order to generate a dense column matrix 906 (e.g., outputs for the channels).

For instance, using equation (3) above for calculating output error gradients 302, sparse-dense matrix computation technique 310 identifies matrix multiplies within the calculation.

Equation (3) is then rewritten as:

$${E}_{I} [ c , y , x ] = {\sum }_{{k}_{y} , {k}_{x} = o}^{{F}_{y} , {F}_{x}} S [ c , y , x , {k}_{y} , {k}_{x} ] \qquad ( 13 )$$

Where S[c,y,x,k_{y},kₓ] is given by:

$$S [ c , {k}_{y} , {k}_{x} ] = {\sum }_{f}^{{N}_{f}} {E}_{O} [ f , \frac{y - {k}_{y}}{{s}_{y}} , \frac{x - {k}_{x}}{{k}_{x}} ] \times W [ f , c , {k}_{y} , {k}_{x} ] \qquad ( 14 )$$

Where, for a fixed value of k_{y}, kₓ, y, and x, equation (15) can be given by:

$${S}^{′} [ c ] = {\sum }_{f}^{{N}_{f}} {E}_{0}^{′} [ f ] \times {W}^{′} [ f , c ] \qquad ( 15 )$$

Where equation (15) includes a matrix-matrix multiply. In some examples, E′₀ (i.e., output error gradients 302) is sparse and W′ (i.e., weights 314) is dense. In such examples, equation (15) can be computed efficiently by vectorizing along c (i.e., channels), which is illustrated in FIG. 9.

In some examples, vectorizing along c can include performing a data layout transformation. The data layout transformation can include transforming W′, E_{I}, and S′ so that c is a fast varying dimension in memory, and transforming E_{O} and E′₀ so that f is a fast varying dimension in memory. Next, each non-zero element E′₀[f] is multiplied with a corresponding vector W′[f,*], wherein * represents c.

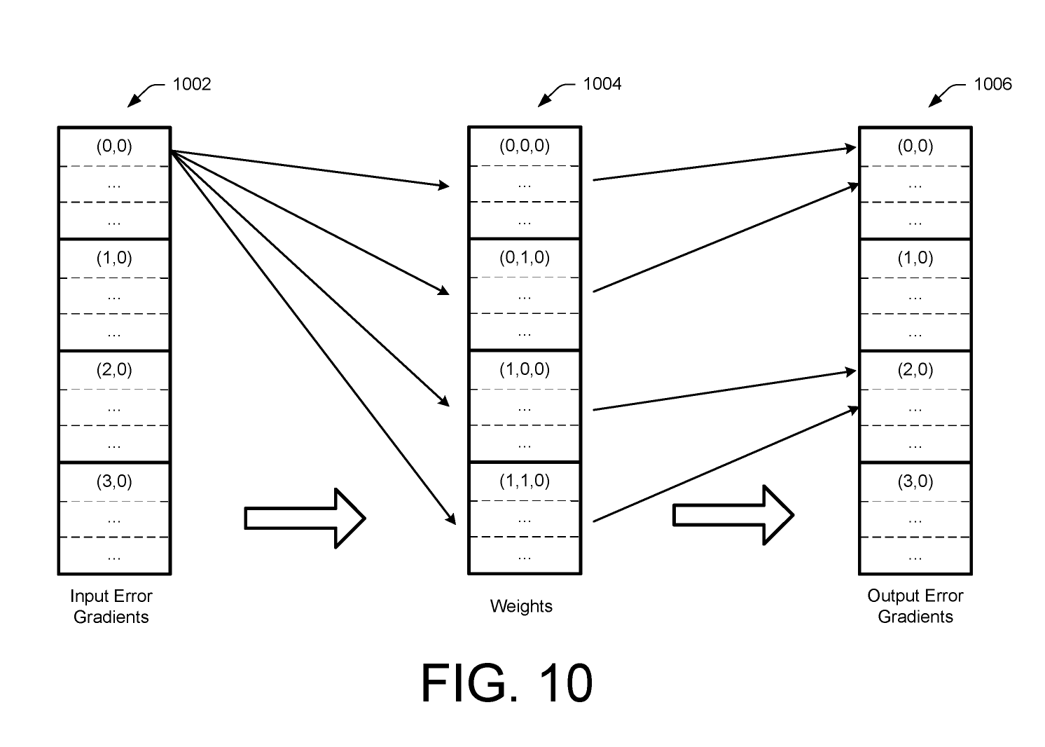

FIG. 10 illustrates an example of a sparse kernel that can be used to perform error gradient calculations during the backward-propagation phase of training a neural network. In the example of FIG. 10, the arrows on the left represent a sparse matrix X dense matrix multiplication between input error gradients 1002 and weights 1004. The arrows on the right between weights 1004 and output error gradients 1006 represent locations in memory where the results of the matrix multiplication are stored.

For example, according to the sparse-dense matrix computation technique 310 for the backward-propagation phase, the sparse matrix multiplication given by equation (15) for all values of k_{y} and kₓ, can be computed without unrolling k_{y} and kₓ. For instance, all of the input error gradients E_{I}[y′,x′,f] contributing to the output error gradients E_{O}[y,x,*] can be written as:

$${E}_{O} [ y , x , * ] ← {E}_{I} [ f , \frac{y - {k}_{y}}{{s}_{y}} , \frac{x - {k}_{x}}{{s}_{x}} ] \qquad ( 16 )$$

Where

$${y}^{′} = \frac{y - {k}_{y}}{{s}_{y}} and {x}^{′} = \frac{x - {k}_{x}}{{s}_{x}}$$

for a given value of k_{y} and kₓ. As such, each input value E_{I}, which is an output from the forward-propagation phase, contributes to multiple output vectors E_{O}, given by:

E_{I}[y′,x′,f]→E_{O}[y′s_{y}+k_{y},x′sₓ+kₓ,*] (17)

Using this relation, sparse-dense matrix computation 310 can identify a position of an output vector E_{O}[y,x,*] for a given input E_{I}[y′,x′,f], and kernel coordinates k_{y} and kₓ, which is illustrated in FIG. 10. For instance, each arrow between E_{I} and W represents a sparse matrix multiplication between input E[y′,x′,*] and weights W[k_{y},kₓ,f,*] for different values of k_{y} and kₓ. The arrows between W and E_{O} shows the position of the output vector resulting from the sparse matrix multiplication.

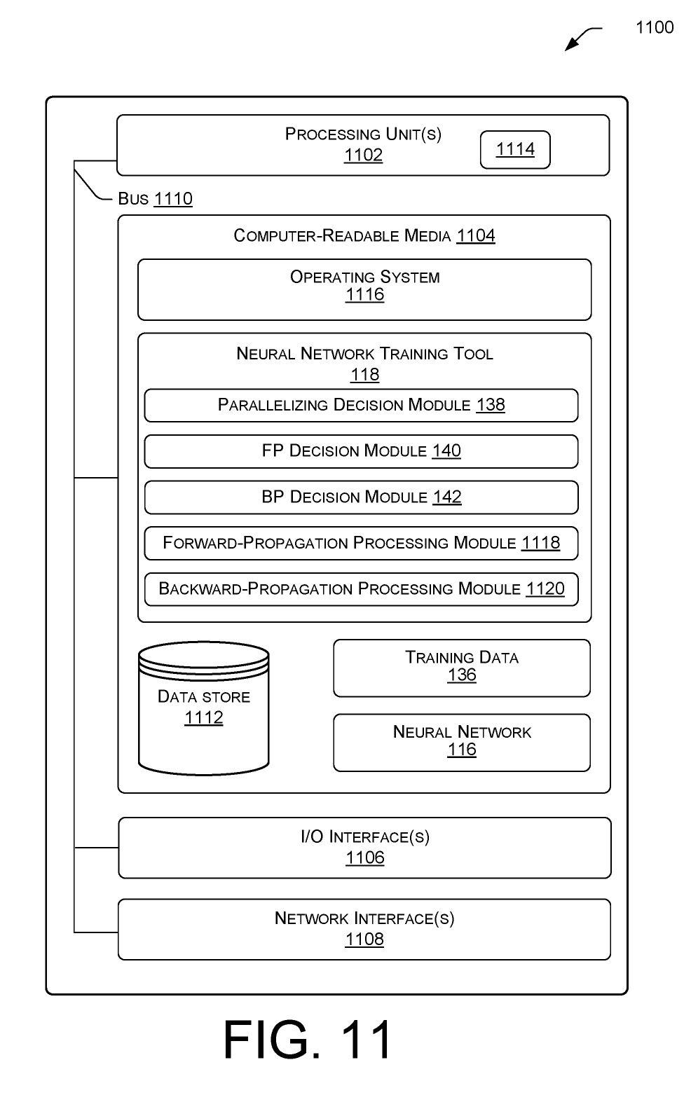

FIG. 11 illustrates select components of an example computing device 1100, such as one of device(s) 106 from FIG. 1. Example computing device 1100 includes one or more processing unit(s) 1102, computer-readable media 1104, input/output interface(s) 1106, and network interface(s) 1108. The components of computing device 1100 are operatively connected, for example, via a bus 1110.

In example computing device 1100, processing unit(s) 1102 may correspond to processing unit(s) 108 and can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc.

Computer-readable media 1104 may correspond to computer-readable media 110, and can store instructions executable by the processing unit(s) 1102. Computer-readable media 1104 can also store instructions executable by external processing units such as by an external CPU, an external GPU, and/or executable by an external accelerator, such as an FPGA type accelerator, a DSP type accelerator, or any other internal or external accelerator. In various examples at least one CPU, GPU, and/or accelerator is incorporated in computing device 1100, while in some examples one or more of a CPU, GPU, and/or accelerator is external to computing device 1100.

Computer-readable media 1104 may include computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. Computer-readable media 1104 can be examples of computer storage media. Thus, the computer-readable media 1104 includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Input/output (I/O) interfaces 1106 allow computing device 1100 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like).

Network interface(s) 1108, which may correspond to network interface(s) 120, can represent, for example, network interface controllers (NICs) or other types of transceiver devices to send and receive communications over a network.

In the illustrated example, computer-readable media 1104 includes a data store 1112. In some examples, data store 1112 includes data storage such as a database, data warehouse, or other type of structured or unstructured data storage. In some examples, data store 1112 includes a corpus and/or a relational database with one or more tables, indices, stored procedures, and so forth to enable data access including one or more of hypertext markup language (HTML) tables, resource description framework (RDF) tables, web ontology language (OWL) tables, and/or extensible markup language (XML) tables, for example. Data store 1112 can store data for the operations of processes, applications, components, and/or modules stored in computer-readable media 1104 and/or executed by processing unit(s) 1102 and/or accelerator(s). In some examples, data store 1112 can store training data 136. Alternately, some or all of the above-referenced data can be stored on separate memories 1114 on board one or more processing unit(s) 1102 such as a memory on board a CPU-type processor, a GPU-type processor, an FPGA-type accelerator, a DSP-type accelerator, and/or another accelerator.

In the illustrated example of FIG. 11, computer-readable media 1104 also includes operating system 1116, which can represent operating system 114. Additionally, computer-readable media 1104 includes neural network 116, training data 136, and neural network training tool 118. Neural network training tool 118 can include one or more modules and/or APIs, which are illustrated as blocks 138, 140, 142, 1118, and 1120, although this is just an example, and the number can vary higher or lower. Functionality described associated with blocks 138, 140, 142, 1118, and 1120 can be combined to be performed by a fewer number of modules and/or APIs or it can be split and performed by a larger number of modules and/or APIs.

Parallelizing decision module 138 includes logic to program processing unit(s) 1102 of computing device 1100 to select from multiple parallelizing techniques when training neural network 116. As described above with reference to FIG. 2 in some examples, the parallelizing techniques can include parallel processing 214 and processing in parallel 216.

FP decision module 140 includes logic to program processing unit(s) 1102 of computing device 1100 to select from multiple computation techniques when training neural network 116. As described above with reference to FIG. 2 in some examples, the computation techniques can include FP matrix multiplication 218 and stencil-based computation technique 220.

BP decision module 142 includes logic to program processing unit(s) 1102 of computing device 1100 to select from multiple backward-propagation techniques to use when training neural network 116. As described above with reference to FIG. 3 in some examples, the backward-propagation techniques can include BP matrix multiplication 308 and sparse-dense matrix computation 310.

Forward-propagation processing module 1118 includes logic to program processing unit(s) 1102 of computing device 1100 to train neural network 116 during a forward-propagation phase of training. For example, forward-propagation processing module 1118 can receive one or more inputs for training neural network. In some examples, forward-propagation processing module 1118 can receive the one or more inputs from training data 136. In some examples, forward-propagation processing module 1118 can receive the one or more inputs from an outside source, such as another networked device.

Forward-propagation processing module 1118 processes the one or more inputs using neural network 116, generating one or more outputs. In some examples, forward-propagation processing module 1118 processes the one or more inputs using the techniques that are selected by parallelizing decision module 138 and FP decision module 140. For example, forward-propagation processing module 1118 can process the one or more inputs using parallel processing 214 and/or processing in parallel 216. Additionally, forward-propagation processing module 1118 can process the one or more inputs using FP matrix multiplication 218 and/or stencil-based computation 220. In some examples, forward-propagation processing module 1118 can process the one or more inputs using different techniques for different layers of neural network 116.

Backward-propagation processing module 1120 includes logic to program processing unit(s) 1102 of computing device 1100 to train neural network 116 during a backward-propagation phase of training. For instance, backward-propagation processing module 1120 can receive outputs from neural network 116 as a result of neural network 116 processing the inputs. Backward-propagation processing module 1120 can use the outputs to determine error gradients associated with each of the inputs. Backward-propagation processing module 1120 can use the error gradients and weights to determine weight deltas.

For example, backward-propagation processing module 1120 can use the techniques selected by BP decision module 142 and parallelizing decision module 138 to calculate the error gradients and weight deltas. In some examples, the selected computation technique can include BP matrix multiplication 308 and/or sparse-dense matrix computation technique 310. Backward-propagation processing module 1120 can use the calculated weight deltas to update the weights within neural network 116. In some examples, backward-propagation processing module 1120 updates the weights using different techniques for one or more layers of neural network 116.

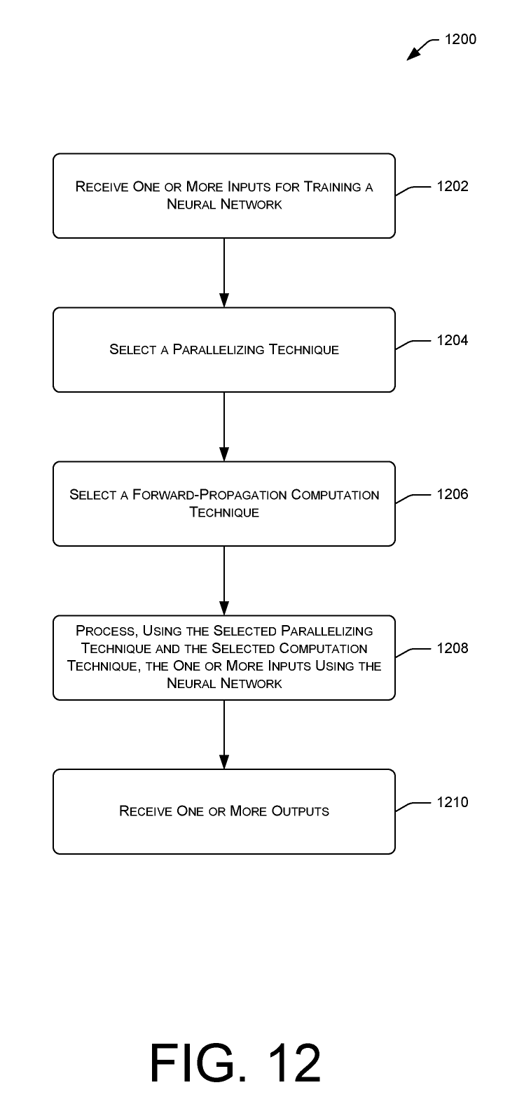

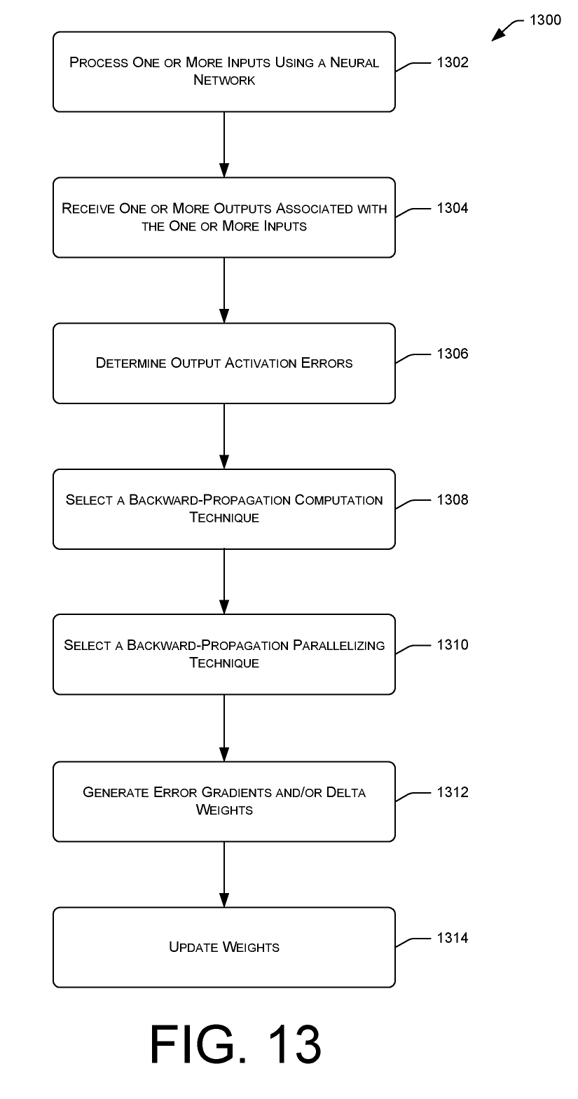

FIGS. 12 and 13 illustrate example processes performed by a neural network training performance optimization framework. The example processes are illustrated as a collection of blocks in a logical flow graph, which represent a sequence of operations that can be implemented in hardware, software, or a combination thereof. The blocks are referenced by numbers. In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 12 is a flow diagram of an example method for performing a forward-propagation phase of training a neural network. At block 1202, one or more inputs for training a neural network are received. For example, neural network training tool 118 receives one or more inputs 210 for training neural network 116. In some examples, forward-propagation processing module 1118 of neural network training tool 118 can receive the one or more inputs 210 from training data 136. In some examples, forward-propagation processing module 1118 can receive the one or more inputs 210 from an outside source, such as another network device. As discussed above, inputs 210 can include, but are not limited to, images, audio recordings, text, video recordings, and/or combinations thereof.

At block 1204, a parallelizing technique is selected for use in training a neural network. For example, neural network training tool 118 selects a parallelizing technique, from a plurality of parallelizing techniques, to use for training neural network 116. For instance, parallelizing decision module 138 of neural network training tool 118 can determine whether to use parallel processing 214 or processing in parallel 216 when training neural network 116, based at least in part on properties associated with neural network 116.

At block 1206, a forward-propagation computation technique is selected. For example, neural network training tool 118 selects a computation technique from a plurality of computation techniques to use for training neural network 116 using inputs 210. For instance, FP decision module 140 of neural network training tool 118 can determine whether to use FP matrix multiplication 218 or stencil-based computation technique 220, based at least in part on the properties associated with neural network 116.

At block 1208, one or more inputs are processed using the neural network. For example, neural network training tool 118 directs neural network 116 to process one or more inputs 210 using the selected parallelizing technique and the selected computation technique. For example, forward-propagation processing module 1118 of neural network training tool 118 can cause neural network 116 to process inputs 210 using parallel processing 214, processing in parallel 216, FP matrix multiplication 218, and stencil-based computation technique 220.

At block 1210, one or more outputs are received from the neural network. For example, neural network training tool 118 receives, based at least in part on the processing, one or more outputs 212. For example, neural network training tool 118 can receive outputs 212 from neural network 116 after neural network 116 processes inputs 210. As discussed above, in some examples, each output 212 can correspond to one of the inputs 210.

FIG. 13 is a flow diagram of an example method for performing a backward-propagation phase of training for a neural network. At block 1302, one or more inputs are processed using a neural network. For example, neural network training tool 118 causes neural network 116 to process one or more inputs 210. For example, forward-propagation processing module 1118 of neural network training tool 118 can cause neural network 116 to process inputs 210. As discussed above, inputs 210 can include, but are not limited to, images, audio recordings, text, video recordings, and/or combinations thereof.

At block 1304, one or more outputs are received from the neural network. For example, neural network training tool 118 receives one or more outputs 212 associated with the one or more inputs 210 processed according to block 1302. For example, neural network training tool 118 can receive outputs 212 from neural network 116 after neural network 116 processes inputs 210. As discussed above, in some examples, each output 212 can correspond to one of the inputs 210.

At 1306, one or more output activation errors are determined. For example, neural network training tool 118 determines, based at least in part on the one or more inputs 210 and the one or more outputs 212, one or more input error gradients 306. For example, backward-propagation processing module 1120 of neural network training tool 118 can determine input error gradients 306 for neural network 116 using inputs 210 and output 212.

At block 1308, a backward-propagation computation technique is selected. For example, neural network training tool 118 selects a backward-propagation computation technique from a plurality of backward-propagation computation techniques to use to train neural network 116. For instance, backward-propagation decision module 142 of neural network training tool 118 can determine whether to use BP matrix multiplication 308 or sparse-dense matrix computation technique 310 at each of the layers 204 of neural network, based at least in part on properties associated with neural network 116.

At block 1308, a parallelizing technique is selected. For example, neural network training tool 118 selects a parallelizing technique, from a plurality of parallelizing techniques, to use for the backward-propagation phase of training neural network 116. For instance, parallelizing decision module 138 of neural network training tool 118 can determine whether to use parallel processing 214 or processing in parallel 216 during the backward-propagation phase, based at least in part on properties associated with neural network 116.

At block 1310, error gradients and weight deltas are calculated. For example, neural network training tool 118 calculates, using the selected backward-propagation technique, output error gradients 302 and weight deltas 304 for neural network 116 based on the one or more input error gradients 306. For example, backward-propagation processing module 1120 of neural network training module 118 can calculate output error gradients 302 and weight deltas 304 using input error gradients 306 and weights 314. In some examples, backward-propagation processing module 1120 calculates output error gradients 302 and weight deltas 304 using BP matrix multiplication 308. In some examples, backward-propagation processing module 1120 calculates output error gradients 302 and weight deltas 304 using sparse-dense matrix computation technique 310.

At block 1314, the weights of the neural network are updated. For example, neural network training tool 118 processes neural network 116 using the selected backward-propagation techniques, wherein processing neural network 116 comprises updating weights 208 associated with one or more layers 204 of neural network 116 using weight deltas 304. For example, backward-propagation processing module 1120 of neural network training module 118 can process neural network using BP matrix multiplication 308 and/or sparse-dense matrix computation technique 310, where the processing includes updating weights 208 of layers 204 using weight deltas 304.

### Example Clauses

A: A method comprising: receiving one or more inputs for training a neural network; selecting a parallelizing technique from a plurality of parallelizing techniques; selecting a forward-propagation computation technique from a plurality of computation techniques; directing the neural network to process the one or more inputs using the selected parallelizing technique and the selected computation technique; and receiving from the neural network, one or more outputs resulting from the neural network processing the one or more inputs.

B: A method as paragraph A recites, wherein the plurality of parallelizing techniques include: parallel processing; and processing in parallel.

C: A method as either paragraph A or paragraph B recites, wherein the plurality of computation techniques include: matrix multiplication; and stencil-based computation.

D: A method as any one or paragraphs A-C recites, wherein selecting a parallelizing technique from the plurality of parallelizing techniques is based, at least in part, on properties associated with the neural network.

E: A method as paragraph D recites, wherein the properties associated with the neural network comprise one or more of: a number of layers within the neural network; a number of feature maps associated with individual layers of the neural network; a data sparsity associated with individual layers of the neural network; a size associated with a convolution filter used to process the inputs; or a stride size.

F: A method as any one of paragraphs A-E recites, wherein selecting a computation technique from the plurality of computation techniques is based, at least in part, on properties associated with the neural network.

G: A method as paragraph F recites, wherein the properties associated with the neural network comprise one or more of: a size of the inputs; a number of inputs; a number of feature maps of the inputs; a stride size; or a size associated with a convolution filter that is used to process the inputs.

H: A method as any one of paragraphs A-G recites, wherein: the neural network includes at least a first layer and a second layer; selecting the parallelizing technique comprises: selecting a first parallelizing technique from the plurality of parallelizing techniques to use for the first layer; and selecting a second parallelizing technique from the plurality of parallelizing techniques to use for the second layer; and selecting the computation technique comprises: selecting a first computation technique from the plurality of computation techniques to use for the first layer; and selecting a second computation technique from the plurality of computation techniques to use for the second layer.

I: A method as any one of paragraphs A-H recites, further comprising: determining, based at least in part on the one or more inputs and the one or more outputs, one or more output activation errors; selecting a backward-propagation computation technique from a plurality of backward-propagation computation techniques; and processing the neural network based, at least in part, on the one or more output activation errors, using the selected backward-propagation technique.

J: A method as paragraph I recites, wherein the plurality of backward-propagation computation techniques include: matrix multiplication; and sparse-dense matrix computation.

K: A method as either paragraph I or paragraph J recites, wherein processing the neural network based, at least in part, on the one or more output activation errors, includes updating weights associated with one or more layers of the neural network.

L: A method as any one of paragraphs I-K recites, further comprising: selecting a backward-propagation parallelization technique from a plurality of backward-propagation parallelization techniques, wherein processing the neural network based, at least in part, on the one or more output activation errors, using the selected backward-propagation technique, further includes processing the neural network based on the selected backward-propagation parallelization technique.

M: A computer-readable medium having computer-executable instructions thereon, the computer-executable instructions configured to perform a method as any one of paragraphs A-L recites.

N: A device comprising: a computer-readable media having computer-executable instructions thereon to configure a computer to perform a method as any one of paragraphs A-L recites, the processing unit adapted to execute the instructions to perform the method as any one of paragraphs A-L recites.

O: A device comprising: a processor; and a computer-readable medium communicatively coupled to the processor; a parallelizing decision module stored on the computer-readable medium and executable by the processor to select, based at least in part on properties of a neural network, a parallelizing technique from a plurality of parallelizing techniques; a forward propagation decision module stored on the computer-readable medium and executable by the processor to select, based at least in part on properties of the neural network, a computation technique from a plurality of computation techniques; and a forward-propagation processing module configured to: receive one or more inputs for training the neural network; cause the neural network to process, based at least in part on the selected parallelizing technique and the selected computation technique, the one or more inputs; and receive, from the neural network, one or more outputs resulting from the neural network processing the one or more inputs.

P: A device as paragraph O recites, wherein: the plurality of parallelizing techniques include: parallel processing; and processing in parallel; and the plurality of computation techniques include: matrix multiplication; and stencil-based computation.

Q: A device as either paragraph O or paragraph P recites, further comprising a backward-propagation decision module stored on the computer-readable media and executable by the processor to: determine, based at least in part on the one or more inputs and the one or more outputs, one or more output activation errors for the neural network; select, based at least in part on properties of the neural network, a backward-propagation technique from a plurality of backward-propagation techniques and a parallelizing technique from a plurality of parallelizing techniques; and process the neural network using the selected backward-propagation technique and the selected parallelizing technique to update weights associated with one or more layers of the neural network.

R: One or more computer-readable media storing computer-executable instructions that, when executed on one or more processors, configure a computer to train a neural network by performing acts comprising: causing the neural network to process one or more inputs; receiving from the neural network, one or more outputs resulting from the neural network processing the one or more inputs; determining, based at least in part on the one or more inputs and the one or more outputs, one or more output activation errors for the neural network; selecting, based at least in part on one or more properties associated with the neural network, a backward-propagation technique from a plurality of backward-propagation techniques; using the selected backward-propagation technique and the one or more output activation errors to calculate error gradients and weight deltas for the neural network; and updating weights associated with one or more layers of the neural network based, at least in part, on the error gradients or the weight deltas.

S: One or more computer-readable media as paragraph R recites, wherein: the selected backward-propagation technique is a sparse-dense matrix multiplication technique; and using the selected backward-propagation technique and the one or more output activation errors to generate input activation errors and weight deltas for the neural network includes: generating one or more sparse matrices using the one or more output activation errors; representing an individual sparse matrix of the one or more sparse matrices using a row index array, a column index array, and a value array; calculating the error gradients and the weight deltas based, at least in part, on the one or more sparse matrices.

T: One or more computer-readable media as either paragraph R or paragraph S recites, wherein the one or more properties associated with the neural network comprise at least one of: a number of layers within the neural network; a number of feature maps associated with individual layers of the neural network; a data sparsity associated with individual layers of the neural network; a size associated with a kernel; and a stride size.

U: One or more computer-readable media as paragraph T recites, wherein the data sparsity is represented as a percentage of values within the individual layers of the neural network that include a zero value.

V: One or more computer-readable media as paragraph U recites, wherein selecting the backward-propagation technique includes selecting a sparse-dense matrix multiplication technique based, at least in part, on the data sparsity being greater than a threshold percentage of values that include a zero value.

### Conclusion

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 106, 122, and/or 1100 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving one or more inputs for training a neural network;
selecting a parallelizing technique from a plurality of parallelizing techniques;
selecting a forward-propagation computation technique from a plurality of computation techniques;
directing the neural network to process the one or more inputs using the selected parallelizing technique and the selected computation technique; and
receiving from the neural network, one or more outputs resulting from the neural network processing the one or more inputs.

2. A method as recited in claim 1, wherein the plurality of parallelizing techniques include:
parallel processing; and
processing in parallel.

3. A method as recited in claim 1, wherein the plurality of computation techniques include:
matrix multiplication; and
stencil-based computation.

4. A method as recited in claim 1, wherein selecting a parallelizing technique from the plurality of parallelizing techniques is based, at least in part, on properties associated with the neural network.

5. A method as recited in claim 4, wherein the properties associated with the neural network comprise one or more of:
a number of layers within the neural network;
a number of feature maps associated with individual layers of the neural network;
a data sparsity associated with individual layers of the neural network;
a size associated with a convolution filter used to process the inputs; or
a stride size.

6. A method as recited in claim 1, wherein selecting a computation technique from the plurality of computation techniques is based, at least in part, on properties associated with the neural network.

7. A method as recited in claim 6, wherein the properties associated with the neural network comprise one or more of:
a size of the inputs;
a number of inputs;
a number of feature maps of the inputs;
a stride size; or
a size associated with a convolution filter that is used to process the inputs.

8. A method as recited in claim 1, wherein:
the neural network includes at least a first layer and a second layer;
selecting the parallelizing technique comprises:
selecting a first parallelizing technique from the plurality of parallelizing techniques to use for the first layer; and
selecting a second parallelizing technique from the plurality of parallelizing techniques to use for the second layer; and
selecting the computation technique comprises:
selecting a first computation technique from the plurality of computation techniques to use for the first layer; and
selecting a second computation technique from the plurality of computation techniques to use for the second layer.

9. A method as recited in claim 1, further comprising:
determining, based at least in part on the one or more inputs and the one or more outputs, one or more output activation errors;
selecting a backward-propagation computation technique from a plurality of backward-propagation computation techniques; and
processing the neural network based, at least in part, on the one or more output activation errors, using the selected backward-propagation technique.

10. A method as recited in claim 9, wherein the plurality of backward-propagation computation techniques include:
matrix multiplication; and
sparse-dense matrix computation.

11. A method as recited in claim 9, wherein processing the neural network based, at least in part, on the one or more output activation errors, includes updating weights associated with one or more layers of the neural network.

12. A method as recited in claim 9, further comprising:
selecting a backward-propagation parallelization technique from a plurality of backward-propagation parallelization techniques,
wherein processing the neural network based, at least in part, on the one or more output activation errors, using the selected backward-propagation technique, further includes processing the neural network based on the selected backward-propagation parallelization technique.

13. A device comprising:
a processor; and
a computer-readable medium communicatively coupled to the processor;
a parallelizing decision module stored on the computer-readable medium and executable by the processor to select, based at least in part on properties of a neural network, a parallelizing technique from a plurality of parallelizing techniques;
a forward propagation decision module stored on the computer-readable medium and executable by the processor to select, based at least in part on properties of the neural network, a computation technique from a plurality of computation techniques; and
a forward-propagation processing module configured to:
receive one or more inputs for training the neural network;
cause the neural network to process, based at least in part on the selected parallelizing technique and the selected computation technique, the one or more inputs; and
receive, from the neural network, one or more outputs resulting from the neural network processing the one or more inputs.

14. A device as recited in claim 13, wherein:
the plurality of parallelizing techniques include:
parallel processing; and
processing in parallel; and
the plurality of computation techniques include:
matrix multiplication; and
stencil-based computation.

15. A device as recited in claim 13, further comprising a backward-propagation decision module stored on the computer-readable media and executable by the processor to:
determine, based at least in part on the one or more inputs and the one or more outputs, one or more output activation errors for the neural network;
select, based at least in part on properties of the neural network, a backward-propagation technique from a plurality of backward-propagation techniques and a parallelizing technique from a plurality of parallelizing techniques; and
process the neural network using the selected backward-propagation technique and the selected parallelizing technique to update weights associated with one or more layers of the neural network.

16. One or more computer-readable media storing computer-executable instructions that, when executed on one or more processors, configure a computer to train a neural network by performing acts comprising:
causing the neural network to process one or more inputs;
receiving from the neural network, one or more outputs resulting from the neural network processing the one or more inputs;
determining, based at least in part on the one or more inputs and the one or more outputs, one or more output activation errors for the neural network;
selecting, based at least in part on one or more properties associated with the neural network, a backward-propagation technique from a plurality of backward-propagation techniques;
using the selected backward-propagation technique and the one or more output activation errors to calculate error gradients and weight deltas for the neural network; and
updating weights associated with one or more layers of the neural network based, at least in part, on the error gradients or the weight deltas.

17. One or more computer-readable media as recited in claim 16, wherein:
the selected backward-propagation technique is a sparse-dense matrix multiplication technique; and
using the selected backward-propagation technique and the one or more output activation errors to generate input activation errors and weight deltas for the neural network includes:
generating one or more sparse matrices using the one or more output activation errors;
representing an individual sparse matrix of the one or more sparse matrices using a row index array, a column index array, and a value array;
calculating the error gradients and the weight deltas based, at least in part, on the one or more sparse matrices.

18. One or more computer-readable media as recited in claim 16, wherein the one or more properties associated with the neural network comprise at least one of:
a number of layers within the neural network;
a number of feature maps associated with individual layers of the neural network;
a data sparsity associated with individual layers of the neural network;
a size associated with a kernel; and
a stride size.

19. One or more computer-readable media as recited in claim 18, wherein the data sparsity is represented as a percentage of values within the individual layers of the neural network that include a zero value.

20. One or more computer-readable media as recited in claim 19, wherein selecting the backward-propagation technique includes selecting a sparse-dense matrix multiplication technique based, at least in part, on the data sparsity being greater than a threshold percentage of values that include a zero value.
